(19) United States
(12) Patent Application Publication
(10) Pub. No.: US 2016/0251014 A1
(43) Pub. Date: Sep. 1, 2016

(54) VEHICLE CONTROL APPARATUS, VEHICLE CONTROL SYSTEM, AND VEHICLE CONTROL METHOD

(71) Applicant: FUJITSU TEN LIMITED, Kobe-shi (JP)

(72) Inventors: Kohichi TOMIYAMA, Kobe-shi (JP); Tomohito INOUE, Kobe-shi (JP)

(73) Assignee: FUJITSU TEN LIMITED, Kobe-shi (JP)

(21) Appl. No.: 15/011,620

(22) Filed: Jan. 31, 2016

(30) Foreign Application Priority Data
Feb. 27, 2015 (JP) 2015-037852

(51) Int. Cl. B60W 30/14; B60W 40/072

(52) U.S. Cl. CPC B60W 30/146; B60W 40/072; B60W 2550/30; B60W 2750/30; B60W 2420/52; B60W 2520/14

(57) ABSTRACT

A vehicle control apparatus of a vehicle, includes: a first calculating unit that calculates a curve curvature radius of a road where the vehicle travels; a second calculating unit that calculates a transverse direction acceleration in a direction intersecting with a traveling direction of the vehicle; a setting unit that sets an allowable upper limit value of the transverse direction acceleration, according to the curve curvature radius; and a control unit that performs a control to accelerate or decelerate the vehicle. In a case where the transverse direction acceleration is larger than the allowable upper limit value, the control unit performs control such that the vehicle accelerates.

### CROSS-REFERENCE TO RELATED APPLICATIONS

This application is based on and claims priority under 35 USC 119 from Japanese Patent Application No. 2015-037852 filed on Feb. 27, 2015, the entire content of which is incorporated herein by reference.

### BACKGROUND

1. Technical Field

The present invention relates to control on traveling of a vehicle.

2. Related Art

There is proposed a vehicle control system (hereinafter, referred to as a “cruise control system”) in which a vehicle control apparatus mounted on a vehicle controls a throttle and a brake such that the vehicle travels.

According to this cruise control system, in a case where a user of the vehicle sets a vehicle speed (for example, 80 km/h) and an inter-vehicle distance (for example, 100 m) in advance, the vehicle control apparatus performs control such that the vehicle travels within the set vehicle speed range and the set inter-vehicle distance range. Specifically, in a case where the vehicle control apparatus has acquired target information on a preceding vehicle from a radar device, it performs control such that the vehicle travels within the set vehicle speed such that the inter-vehicle distance between the vehicle and the preceding vehicle becomes the set inter-vehicle distance. Meanwhile, in a case where the vehicle control apparatus has not acquired any target information on a preceding vehicle, it performs control such that the vehicle travels within the set vehicle speed. Also, as an explanatory material on a technology related to the present invention, there is proposed JP-A-2005-297814.

### SUMMARY OF INVENTION

By the way, in a case where the vehicle accelerates on the basis of the set vehicle speed, an acceleration in a direction intersecting with the traveling direction of the vehicle (hereinafter, referred to as a “traverse direction acceleration”) occurs. Especially, if the vehicle accelerates on a curve, a relatively large centrifugal acceleration toward the outside of the curve occurs, which reduces the comfort of the user of the vehicle with respect to driving.

At least one embodiment of the present invention provides appropriately control the speed of a vehicle in a case where the vehicle travels on a curve using a cruise control system.

[1] The at least one embodiment of the present invention provides a vehicle control apparatus of a vehicle, including: a first calculating unit that calculates a curve curvature radius of a road where the vehicle travels; a second calculating unit that calculates a transverse direction acceleration in a direction intersecting with a traveling direction of the vehicle; a setting unit that sets an allowable upper limit value of the transverse direction acceleration, according to the curve curvature radius; and a control unit that performs a control to accelerate or decelerate the vehicle, in which, in a case where the transverse direction acceleration is larger than the allowable upper limit value, the control unit performs control such that the vehicle accelerates.

[2] It may be the vehicle control apparatus according to [1], in which: as the curve curvature radius increases, the setting unit sets the allowable upper limit value to a larger value.

[3] It may be the vehicle control apparatus according to [2], further including: an acquiring unit that acquires target information on a preceding vehicle of the vehicle, in which, curve curvature radiuses are classified into three sections including a first section, a second section and a third section listed in an ascending order of distances from center points of osculating circles, and in a case where the curve curvature radius of the road where the vehicle travels is classified into the second section, the setting unit changes the allowable upper limit value depending on whether there is target information on the preceding vehicle.

[4] It may be the vehicle control apparatus according to [3], in which: in a case where a transition from a state where any target information on the preceding vehicle has not been acquired transitions to a state where target information on the preceding vehicle has been acquired, the setting unit sets the allowable upper limit value to a value larger than the allowable upper limit value in the state where any target information on the preceding vehicle has not been acquired, such that a speed of the vehicle does not exceed a speed set in advance by a user.

[5] It may be the vehicle control apparatus according to [3] or [4], in which: in a case where a transition from a state where target information on the preceding vehicle has been acquired transitions to a state where any target information on the preceding vehicle has not been acquired, the setting unit sets the allowable upper limit value to a value which is close to the allowable upper limit value in the state where any target information on the preceding vehicle has been acquired.

[6] The at least one embodiment of the present invention provides a vehicle control system including: a vehicle control apparatus that includes: a first calculating unit that calculates a curve curvature radius of a road where the vehicle travels; a second calculating unit that calculates a transverse direction acceleration in a direction intersecting with a traveling direction of the vehicle; a setting unit that sets an allowable upper limit value of the transverse direction acceleration, according to the curve curvature radius; and a control unit that performs a control to accelerate or decelerate the vehicle, where in a case where the transverse direction acceleration is larger than the allowable upper limit value, the control unit performs control such that the vehicle accelerates; a yaw rate sensor that detects a yaw rate of the vehicle; a vehicle speed sensor that detects a speed of the vehicle; and a radar device that derives target information related to a preceding vehicle of the vehicle.

[7] The least one embodiment of the present invention provides a vehicle control method including: calculating the curve curvature radius of a road where a vehicle travels; calculating a transverse direction acceleration in a direction intersecting with the traveling direction of the vehicle; setting an allowable upper limit value of the transverse direction acceleration, according to the curve curvature radius; and performing a control to accelerate or decelerate the vehicle, in which, in a case where the transverse direction acceleration is larger than the allowable upper limit value, the control is performed such that the vehicle decelerates.

According to the at least one embodiment of the present invention, the vehicle control apparatus can reduce a relatively large transverse direction acceleration on a vehicle, and can prevent a reduction in the comfort of the user of the vehicle with respect to driving.

Also, according to the at least one embodiment of the present invention, the vehicle control apparatus can control the transverse direction acceleration of the vehicle such that the transverse direction acceleration does not cause the user of the vehicle to feel uncomfortable, and can prevent a reduction in the comfort of the user of the vehicle with respect to driving.

Also, according to the at least one embodiment of the present invention, the vehicle control apparatus can surely perform control such that the vehicle follows the preceding vehicle even if the transverse direction acceleration on the vehicle increases to a certain extent, and can suppress a reduction in the comfort of the user of the vehicle with respect to driving.

Also, according to the at least one embodiment of the present invention, even in a case where the preceding vehicle makes a lane change from the lane of the vehicle to an adjacent lane, the speed of the vehicle is not changed rapidly, whereby it is possible to prevent the user of the vehicle from feeling uncomfortable with the traveling state of the vehicle.

### BRIEF DESCRIPTION OF DRAWINGS

FIG. 1 is a view for explaining the configuration of a vehicle control system.

FIG. 2 is a flow illustrating processes of a control unit.

FIG. 3 is a view illustrating allowable upper limit values of transverse direction accelerations corresponding to curve curvature radiuses and existence or non-existence of a preceding vehicle.

FIG. 4 is a view illustrating a situation in which, when a vehicle has traveled on a curved lane, a preceding vehicle has made a lane change.

### DESCRIPTION OF EMBODIMENTS

Hereinafter, an embodiment of the present invention will be described with reference to the accompanying drawings.

### First Embodiment

<1. Block Diagram of System>

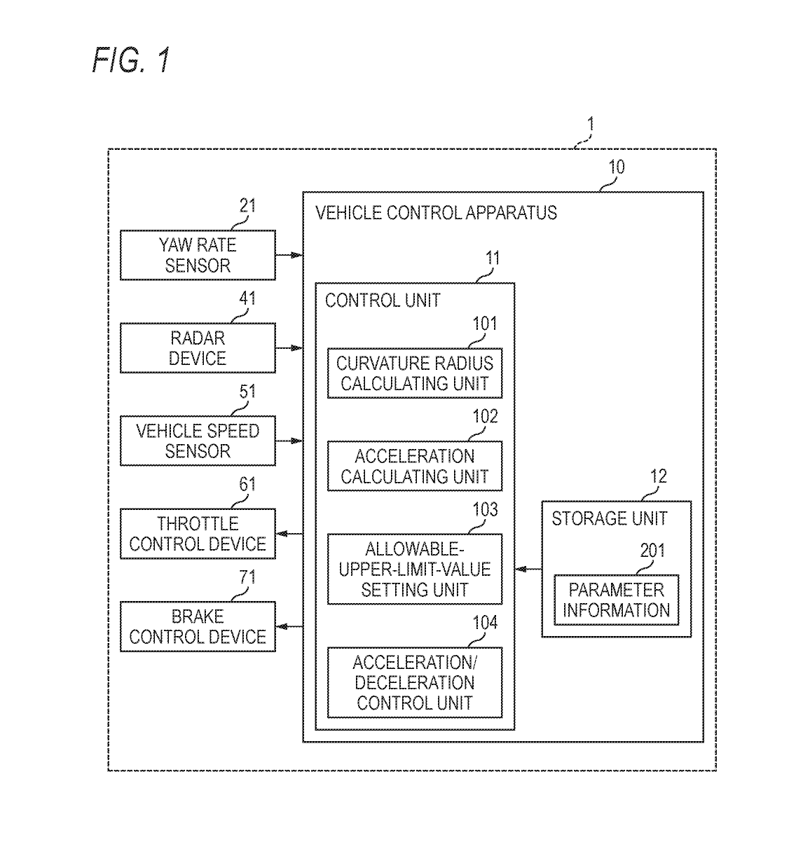

The configuration of a vehicle control system of the present embodiment will be described with reference to FIG. 1. FIG. 1 is a view for explaining the configuration of a vehicle control system 1. The vehicle control system 1 is a system for performing control such that a vehicle travels within a set vehicle speed while increasing or decreasing the traveling speed of the vehicle. Hereinafter, sometimes, as an expression representing any one state of a state where the vehicle accelerates and a state where the vehicle decelerates, an expression “acceleration/deceleration” will be used.

The vehicle control system 1 mainly includes a vehicle control apparatus 10, a yaw rate sensor 21, a radar device 41, a vehicle speed sensor 51, a throttle control device 61, and a brake control device 71.

The vehicle control apparatus 10 is installed in the vehicle, and acquires a variety of information usable to perform control to accelerate or decelerate the vehicle, from the yaw rate sensor 21, the radar device 41, and the vehicle speed sensor 51. Also, on the basis of the variety of acquired information, the vehicle control apparatus 10 outputs a signal related to acceleration on the vehicle, to the throttle control device 61, or outputs a signal related to deceleration on the vehicle, to the brake control device 71, thereby controlling acceleration/deceleration of the vehicle.

The yaw rate sensor 21 is a sensor for detecting the yaw rate of the vehicle on a road where the vehicle travels. The yaw rate of the vehicle is used to calculate the curvature radius of a curve where the vehicle travels (hereinafter, referred to as a “curve curvature radius”) as will be described below.

The radar device 41 is installed in the vehicle and detects targets existing around the vehicle. Specifically, the radar device 41 detects target information including the actual inter-vehicle distance, angle, relative speed, and the like of a target corresponding to a preceding vehicle. A preceding vehicle is a vehicle traveling in front of the vehicle on a lane where the vehicle travels, in the same direction as the traveling direction of the vehicle.

The radar device 41 outputs the target information to the vehicle control apparatus 10. In a case where the vehicle control apparatus 10 acquires a plurality of target information items from the radar device 41, it determines a target having a target information item satisfying, for example, the following three conditions, as a target of a preceding vehicle. The first condition is a condition that the actual inter-vehicle distance of the corresponding target should be the minimum distance of the actual inter-vehicle distances of the detected targets. The second condition is a condition that the angle of the corresponding target should be within the range of the lane of the vehicle. The third condition is a condition that the corresponding target should move in the same direction as the traveling direction of the vehicle. Whether a target moves in the same direction as the traveling direction of the vehicle can be determined on the basis of the relative speed of the corresponding target.

The vehicle speed sensor 51 is a sensor for detecting a speed at which the vehicle travels (hereinafter, referred to as the “vehicle speed”) on the basis of the number of revolutions of the axel of the vehicle.

Further, information detected by the individual sensors including the radar device 41 is output to the vehicle control apparatus 10.

The throttle control device 61 controls the opening of the throttle of the engine on the basis of a signal related to acceleration and received from the vehicle control apparatus 10, thereby accelerating the vehicle.

The brake control device 71 puts a brake on the wheels of the vehicle on the basis of a signal related to deceleration and received from the vehicle control apparatus 10, thereby decelerating the vehicle.

Now, the configuration of the vehicle control apparatus 10 will be described. The vehicle control apparatus 10 mainly includes a control unit 11 and a storage unit 12.

The control unit 11 includes a micro computer including a CPU and the like, and performs general control on the vehicle control apparatus 10.

The storage unit 12 is composed of an erasable programmable read only memory (EPROM), a flash memory, or the like, and stores parameter information 201. The parameter information 201 is information usable for controlling acceleration/deceleration of the vehicle, and is information including an allowable upper limit value of a transverse direction acceleration to be described below.

The control unit 11 mainly includes a curvature radius calculating unit 101, an acceleration calculating unit 102, an allowable-upper-limit-value setting unit 103, and an acceleration/deceleration control unit 104. Hereinafter, processes which the individual units perform will be described with reference to a process flow chart.

<2. Processes>

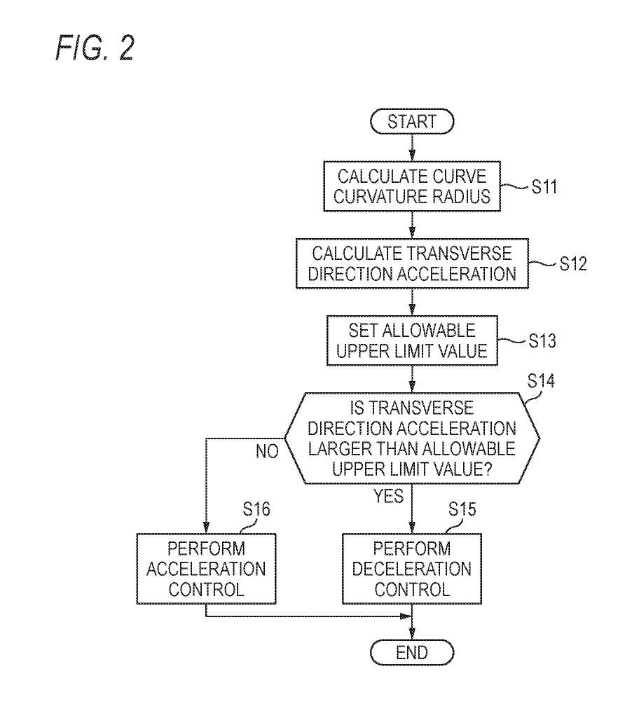

FIG. 2 is a flow chart illustrating processes of the control unit 11. These processes are repeated in a cycle (for example, 50 msec) in which the radar device 21 derives target information on targets existing around the vehicle.

In STEP S11, the curvature radius calculating unit 101 calculates the curvature radius of a curve where the vehicle travels, on the basis of the yaw rate of the vehicle detected by the yaw rate sensor 21.

Subsequently, in STEP S12, the acceleration calculating unit 102 calculates the transverse direction acceleration. On the assumption that the vehicle speed is V (m/s) and the curve curvature radius is R (m), the transverse direction acceleration Sa (G) can be calculated by Expression 1.

$$Sa = \frac{{V}^{2}}{R} \times \frac{1}{9.8} \qquad [ Expression 1 ]$$

Subsequently, in STEP S13, on the basis of the curve curvature radius calculated by the curvature radius calculating unit 101, the allowable-upper-limit-value setting unit 103 sets an allowable upper limit value of the transverse direction acceleration of the vehicle. The allowable upper limit value is the maximum value of the transverse direction acceleration which occurs during traveling of the vehicle but does not reduce the comfort of the user of the vehicle with respect to driving.

In a case where the transverse direction acceleration calculated by the acceleration calculating unit 102 is larger than the allowable upper limit value (“Yes” in STEP S14), the acceleration/deceleration control unit 104 outputs a signal related to deceleration to the brake control device 71 such that a target speed is achieved. The target speed Pv (m/s) can be calculated by Expression 2.

Pv=\sqrt{Sa×R×9.8} [Expression 2]

As a result, in STEP S15, on the basis of the signal related to deceleration and received from the acceleration/deceleration control unit 104, the brake control device 71 decelerates the vehicle. Therefore, a relatively high transverse direction acceleration on the vehicle is reduced, whereby it is possible to prevent a reduction in the comfort of the user of the vehicle with respect to driving.

Meanwhile, in a case where the transverse direction acceleration is equal to or smaller than the allowable upper limit value (“No” in STEP S14), the acceleration/deceleration control unit 104 outputs a signal related to acceleration to the throttle control device 61 such that the target speed Pv is achieved. As a result, in STEP S16, on the basis of the signal related to acceleration and received from the acceleration/deceleration control unit 104, the throttle control device 61 accelerates the vehicle.

In this case, the above described control is performed within a range which does not exceed the set vehicle speed of the vehicle. The set vehicle speed is a speed set in advance by the user of the vehicle. The user of the vehicle sets the allowable maximum speed of the vehicle. This setting is performed, for example, using an operation unit installed in the steering wheel of the vehicle.

<3. Setting of Allowable Upper Limit Value>

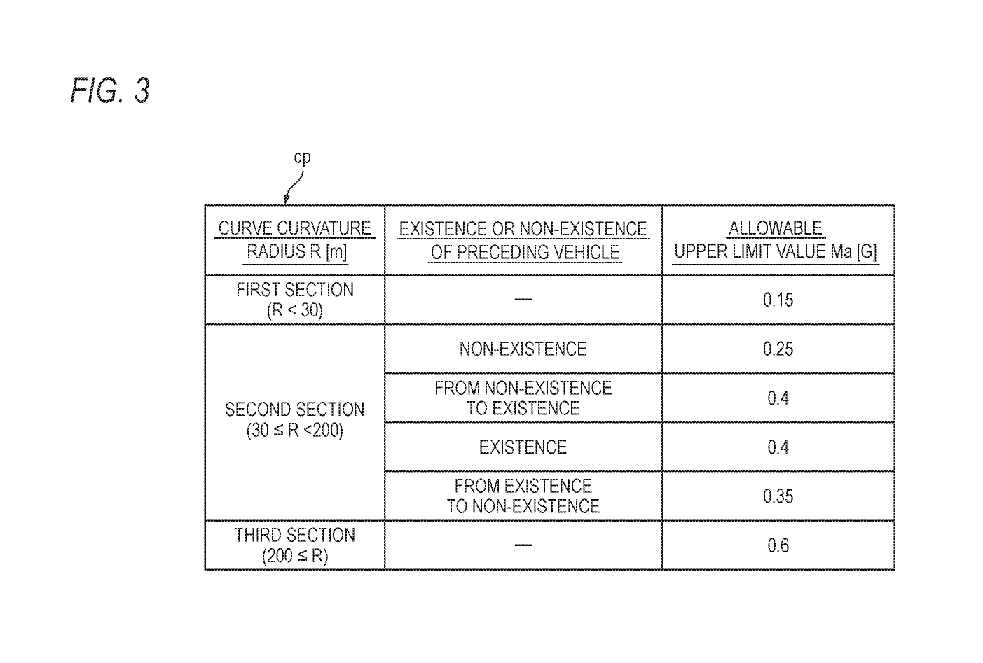

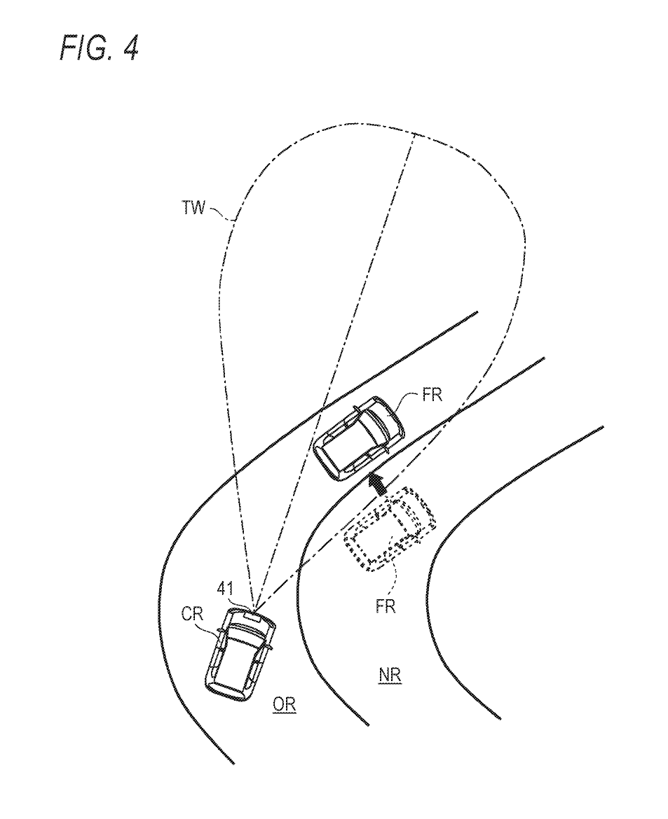

Now, the process of STEP S13 which is performed to set the allowable upper limit value as described above with reference to the process flow chart will be described in detail with reference to FIGS. 3 and 4.

A correspondence view cp shown in FIG. 3 is a view illustrating curve curvature radiuses R (m) and allowable upper limit values Ma (G) of the transverse direction acceleration according to whether there is any preceding vehicle.

The curve curvature radiuses are classified into, for example, a first section, a second section, and a third section according to their lengths. In ascending order of distances from the center points of osculating circles, the first section, the second section, and the third section are listed. Specifically, the first section is a section where the distances from the center points of osculating circles are less than 30 m. The second section is a section where the distances from the center points of osculating circles are equal to or larger than 30 m and are less than 200 m. The third section is a section where the distances from the center points of osculating circles are equal to or larger than 200 m. Here, each value of the first section is a value obtained in view of a case where the vehicle travels on a rotary such as a roundabout.

Further, the allowable-upper-limit-value setting unit 103 sets an allowable upper limit value Ma according to a section to which an actual measurement value of the curve curvature radius R (hereinafter, referred to as the “actual measurement value of the curve R”) calculated by the curvature radius calculating unit 101 belong. Specifically, in a case where the actual measurement value of the curve R belongs to the first section, the allowable-upper-limit-value setting unit 103 sets the allowable upper limit value Ma to 0.15 G.

Also, in a case where the actual measurement value of the curve R belongs to the second section, the allowable-upper-limit-value setting unit 103 sets the allowable upper limit value Ma to any one of 0.25 G, 0.35 G, and 0.4 G. According to whether there is a preceding vehicle, one value of those values is set as the allowable upper limit value Ma. Setting of the allowable upper limit value Ma as described above will be described below.

Further, in a case where the actual measurement value of a curve R belongs to the third section, the allowable-upper-limit-value setting unit 103 sets an allowable upper limit value Ma to 0.6 G.

As described above, as the actual measurement value of the curve R increases, the allowable-upper-limit-value setting unit 103 sets the allowable upper limit value Ma to a larger value. As a result, the transverse direction acceleration Sa of the vehicle is controlled such that it does not cause the user of the vehicle to feel uncomfortable, whereby it is possible to prevent a reduction in the comfort of the user of the vehicle with respect to driving.

<4. Setting of Allowable Upper Limit Value According to Existence or Non-Existence Of Preceding Vehicle>

Now, setting of the allowable upper limit value Ma according to existence or non-existence of a preceding vehicle will be described. In the case where the actual measurement value of the curve R belongs to the second section, the allowable-upper-limit-value setting unit 103 changes the allowable upper limit value Ma depending on existence or non-existence of a preceding vehicle.

The reason why the allowable-upper-limit-value setting unit 103 determines whether there is any target information on a preceding vehicle only in the case where the actual measurement value of the curve R belongs to the second section as described above is as follows. The reason is that, in the case where the actual measurement value of the curve R belongs to the first section, in a case where target information on a preceding vehicle has been acquired, if the allowable upper limit value Ma is set to be larger than 0.15 G, the transverse direction acceleration Sa becomes relatively large, and thus may reduce the comfort of the user of the vehicle with respect to driving.

Meanwhile, in the case where the actual measurement value of the curve R belongs to the third section, the allowable upper limit value Ma is set to a relatively large value. For this reason, in a case where target information on a preceding vehicle has been acquired, although it is considered that the vehicle accelerates in order to follow the preceding vehicle, the allowable upper limit value Ma does not need to be set to be larger than 0.6 G.

Therefore, in a case where the actual measurement value of the curve R belongs to any one of the first section and the third section, the allowable-upper-limit-value setting unit 103 sets the allowable upper limit value Ma depending on the corresponding section, regardless of whether there is target information on a preceding vehicle. In other words, the allowable-upper-limit-value setting unit 103 sets the allowable upper limit value Ma regardless of whether the vehicle travels alone or along a preceding vehicle. Only in the case where the actual measurement value of the curve R belongs to the second section, the allowable-upper-limit-value setting unit 103 sets the allowable upper limit value Ma depending on whether there is target information on a preceding vehicle. Hereinafter, a specific example of setting of the allowable upper limit value Ma according to whether there is target information on a preceding vehicle will be described.

As shown in FIG. 3, in a case where the actual measurement value of the curve R belongs to the second section and any target information on a preceding vehicle has not been acquired, the allowable-upper-limit-value setting unit 103 sets the allowable upper limit value Ma to 0.25 G. This case is a case where temporally consecutive target data items on a preceding vehicle have not been acquired in a certain transmission cycle and the next transmission cycle.

Meanwhile, in a case where a state where any target information on a preceding vehicle has not been acquired transitions to a state where target information on a preceding vehicle has been acquired, the allowable-upper-limit-value setting unit 103 sets the allowable upper limit value Ma to a value larger than the allowable upper limit value Ma in the state where any target information on a preceding vehicle has not been acquired, such that the vehicle speed does not exceed the vehicle speed set in advance by the user. Specifically, the allowable-upper-limit-value setting unit 103 sets the allowable upper limit value Ma to a value (for example, 0.4 G) larger than 0.25 G, such that the vehicle speed becomes equal to or lower than the vehicle speed (for example, 50 km/h) set in advance by the user.

Here, the case where a state where any target information on a preceding vehicle has not been acquired transitions to a state where target information on a preceding vehicle has been acquired indicates, for example, a case as shown in FIG. 4. FIG. 4 is a view illustrating a situation in which, when a vehicle CR has traveled on a curved lane, a preceding vehicle has made a lane change.

The radar device 41 of the vehicle CR shown in FIG. 4 transmits a transmission wave TW having a predetermined transmission range, and derives target information on targets included in the transmission range. However, when the radar device 41 outputs the transmission wave TW in a certain transmission cycle, a vehicle FR traveling in front of the vehicle CR is traveling on an adjacent lane NR. The adjacent lane NR is a lane adjacent to the lane OR of the vehicle CR. In this case, since the vehicle FR exists outside the transmission range of the transmission wave TW of the radar device 41, any target information on a preceding vehicle is not derived.

In contrast, after the certain transmission cycle, if the vehicle FR changes from the adjacent lane NR into the lane OR when the radar device 41 outputs the transmission wave TW in another transmission cycle, the radar device 41 derives target information on the vehicle FR as target information on a preceding vehicle (the preceding vehicle FR), and outputs the derived target information to the vehicle control apparatus 10.

Therefore, the target information on the preceding vehicle FR has been derived. In the case where the state where any target information on the preceding vehicle FR has not been acquired transitions to the state where target information on the preceding vehicle FR has been acquired due to a lane change of the preceding vehicle FR, the allowable-upper-limit-value setting unit 103 sets the allowable upper limit value Ma to a value larger than the allowable upper limit value Ma in the state where any target information on the preceding vehicle FR has not been acquired, such that the vehicle speed does not exceed a set vehicle speed. In other words, the allowable-upper-limit-value setting unit 103 sets the allowable upper limit value Ma for easing restrictions as compared to the allowable upper limit value Ma in the state where any target information on the preceding vehicle FR has not been acquired, within the set vehicle speed. Therefore, even if the transverse direction acceleration Sa on the vehicle CR increases to a certain extent, the vehicle control apparatus 10 can surely perform control such that the vehicle CR follows the preceding vehicle FR, and can suppress a reduction in the comport of the user of the vehicle CR with respect to driving.

In the case where the actual measurement value of the curve R belongs to the second section, and target information on a preceding vehicle has been acquired, the allowable-upper-limit-value setting unit 103 sets the allowable upper limit value Ma to 0.4 G. This case is a case where temporally consecutive target data items on a preceding vehicle have been acquired in a certain transmission cycle and the next transmission cycle.

Meanwhile, in a case where a state where target information on a preceding vehicle has been acquired transitions to a state where any target information on the preceding vehicle has not been acquired, the allowable-upper-limit-value setting unit 103 sets the allowable upper limit value Ma to a value which is close to the allowable upper limit value Ma in the state where target information on the preceding vehicle has been acquired. Specifically, the allowable-upper-limit-value setting unit 103 sets the allowable upper limit value Ma to, for example, 0.35 G.

Since the vehicle control apparatus 10 sets the allowable upper limit value Ma to a value which is appropriately the same as the allowable upper limit value Ma in the state where target information on the preceding vehicle has been acquired, even in the case where the preceding vehicle changes from the lane OR into the adjacent lane NR, the speed of the vehicle CR is not changed rapidly, whereby it is possible to prevent the user of the vehicle CR from feeling uncomfortable with the traveling state of the vehicle.

<Modifications>

Although the embodiment of the present invention has been described above, the present invention is not limited to the above described embodiment, and can be modified in various forms. Hereinafter, these modifications will be described. All forms including the above described embodiment and the following embodiments to be described below can be appropriately combined.

In the above described embodiment, the ranges of the sections of curve curvature radiuses R, the allowable upper limit values Ma, and the like have been described with the specific values. However, these values are examples, and other values may be used as long as the object described in the embodiment can be achieved.

Also, in the above described embodiment, curve curvature radiuses R are classified into the first to third sections. However, the number of sections of curve curvature radiuses R is an example, and may be two or more.

Also, in the above described embodiment, with respect to the state where any target information on the preceding vehicle FR has not been acquired and the state where target information on the preceding vehicle FR has been acquired, a case where the preceding vehicle FR has made a lane change between the lane OR and the adjacent lane NR has been described as an example. With respect to this, even if a transition between the state where any target information on the preceding vehicle FR has been acquired and state where target information on the preceding vehicle FR has not been acquired occurs due to any other situation such as a case where the preceding vehicle FR in the transmission range of the transmission wave TW has gotten out of the transmission range by accelerating, the contents described in the embodiment can be applied.

Also, in the above described embodiment, in a case where a state where target information on a preceding vehicle has been acquired transitions to a state where any target information on the preceding vehicle has not been acquired, the allowable-upper-limit-value setting unit 103 sets the allowable upper limit value Ma to a value (0.35 G) which is appropriately the same as the allowable upper limit value Ma in the state where target information on the preceding vehicle has been acquired. However, besides the approximate value, the same value (0.4 G) may be set.

Also, in the above described embodiment, the curvature radius calculating unit 101 of the control unit 11 calculates the curve curvature radius of a road where the vehicle CR travels, using the yaw rate detected by the yaw rate sensor 21. However, the curvature radius calculating unit 101 may calculate the curve curvature radius on the basis of information from a sensor for detecting the rotation angle of the steering wheel of the vehicle.

Also, in the above described embodiment, target information is acquired from the radar device 41. However, target information may be acquired from a device other than the radar device 41 as long as the information is usable for the vehicle control apparatus 10 to perform control on acceleration/deceleration of the vehicle. For example, target information may be acquired from images taken by cameras.

Also, in the above described embodiment, various functions are implemented in a software wise by arithmetic processing of the CPU according to programs. However, some of those functions may be implemented by electric hardware circuits. Also, conversely, some of functions which are implemented by hardware circuits may be implemented in a software wise.

What is claimed is:

1. A vehicle control apparatus of a vehicle, comprising:
a first calculating unit that calculates a curve curvature radius of a road where the vehicle travels;
a second calculating unit that calculates a transverse direction acceleration in a direction intersecting with a traveling direction of the vehicle;
a setting unit that sets an allowable upper limit value of the transverse direction acceleration, according to the curve curvature radius; and
a control unit that performs a control to accelerate or decelerate the vehicle,
wherein, in a case where the transverse direction acceleration is larger than the allowable upper limit value, the control unit performs control such that the vehicle accelerates.

2. The vehicle control apparatus according to claim 1, wherein:
as the curve curvature radius increases, the setting unit sets the allowable upper limit value to a larger value.

3. The vehicle control apparatus according to claim 2, further comprising:
an acquiring unit that acquires target information on a preceding vehicle of the vehicle,
wherein, curve curvature radiuses are classified into three sections including a first section, a second section and a third section listed in an ascending order of distances from center points of osculating circles, and
in a case where the curve curvature radius of the road where the vehicle travels is classified into the second section, the setting unit changes the allowable upper limit value depending on whether there is target information on the preceding vehicle.

4. The vehicle control apparatus according to claim 3, wherein:
in a case where a transition from a state where any target information on the preceding vehicle has not been acquired transitions to a state where target information on the preceding vehicle has been acquired, the setting unit sets the allowable upper limit value to a value larger than the allowable upper limit value in the state where any target information on the preceding vehicle has not been acquired, such that a speed of the vehicle does not exceed a speed set in advance by a user.

5. The vehicle control apparatus according to claim 3, wherein:
in a case where a transition from a state where target information on the preceding vehicle has been acquired transitions to a state where any target information on the preceding vehicle has not been acquired, the setting unit sets the allowable upper limit value to a value which is close to the allowable upper limit value in the state where any target information on the preceding vehicle has been acquired.

6. A vehicle control system comprising:
a vehicle control apparatus that includes:
a first calculating unit that calculates a curve curvature radius of a road where the vehicle travels;
a second calculating unit that calculates a transverse direction acceleration in a direction intersecting with a traveling direction of the vehicle;
a setting unit that sets an allowable upper limit value of the transverse direction acceleration, according to the curve curvature radius; and
a control unit that performs a control to accelerate or decelerate the vehicle, where in a case where the transverse direction acceleration is larger than the allowable upper limit value, the control unit performs control such that the vehicle accelerates;
a yaw rate sensor that detects a yaw rate of the vehicle;
a vehicle speed sensor that detects a speed of the vehicle; and
a radar device that derives target information related to a preceding vehicle of the vehicle.

7. A vehicle control method comprising:
calculating the curve curvature radius of a road where a vehicle travels;
calculating a transverse direction acceleration in a direction intersecting with the traveling direction of the vehicle;
setting an allowable upper limit value of the transverse direction acceleration, according to the curve curvature radius; and
performing a control to accelerate or decelerate the vehicle,
wherein, in a case where the transverse direction acceleration is larger than the allowable upper limit value, the control is performed such that the vehicle decelerates.
